(19) United States
(12) Patent Application Publication
(10) Pub. No.: US 2006/0081754 A1
(43) Pub. Date: Apr. 20, 2006

(54) Axle-up (leverage lifting style trailer jack)

(76) Inventor: Andrew Eugene Jackson, Logan, NM (US)

Correspondence Address: Jackson Walker, LLP;Attn: Mark H. Miller, 112 E. Pecan, Suite 2100, San Antonio, TX, 78205, US

(21) Appl. No.: 10/857,755

(22) Filed: Oct. 18, 2004

(51) Int. Cl. A47F 5/00; F16M 13/00

(52) U.S. Cl. 248/352

(57) ABSTRACT

An improved jack for using leverage and the momentum of the vehicle or trailer to be lifted to raise the vehicle or trailer. The jack has a cradle to engage the axle of the vehicle or trailer to be lifted. The cradle is adapted to prevent the vehicle or trailer from slipping off the jack. The cradle is connected to a telescoping member which is inserted into a post that is connected to a based plate. The base plate is configured to allow the post and telescoping member to pivot to a vertical position as the vehicle or trailer is driver over the jack.

This patent claims priority from and incorporates by reference U.S. application Ser. No. 60/524,384 filed Nov. 20, 2003.

### FIELD OF THE INVENTION

Applicant's invention relates to a device used to lift a vehicle or trailer off the ground to facilitate maintenance. More particularly, Applicant's invention relates to a jack having no moving parts designed to utilize the momentum of a moving vehicle or trailer to lift said vehicle or trailer.

### SUMMARY OF THE INVENTION

The invention is a jack (a mechanism for exerting pressure for lifting a heavy body) that, when functioning, has no moving parts. Rather, the jack utilizes the momentum of the body to be lifted and leverage to lift the body.

In one embodiment of the invention, a base is provided. At one end of the base, a pivot point is attached to the underside of the base. The pivot point lifts that end of the base off of the ground. Projecting from the top of the base, on the pivot-point side of the base, is a supporting post. The post may be further secured to the base with bracing. Near the distal end and on opposed sides of the supporting post are apertures to allow the insertion of a height adjustment pin. The distal end of the post defines an aperture into which a telescoping member is inserted. On the near end and opposed sides of the telescoping member are apertures which allow insertion of the height adjustment pin, through the supporting post, to lock the telescoping member into place. Attached to the distal end of the telescoping member is a cradle to hold an axle of the vehicle or trailer to be lifted. The cradle is shaped such that the lifted body does not slip off the cradle.

### BRIEF DESCRIPTION OF THE DRAWINGS

FIG. 1 is a side perspective view of a first embodiment of the claimed invention.

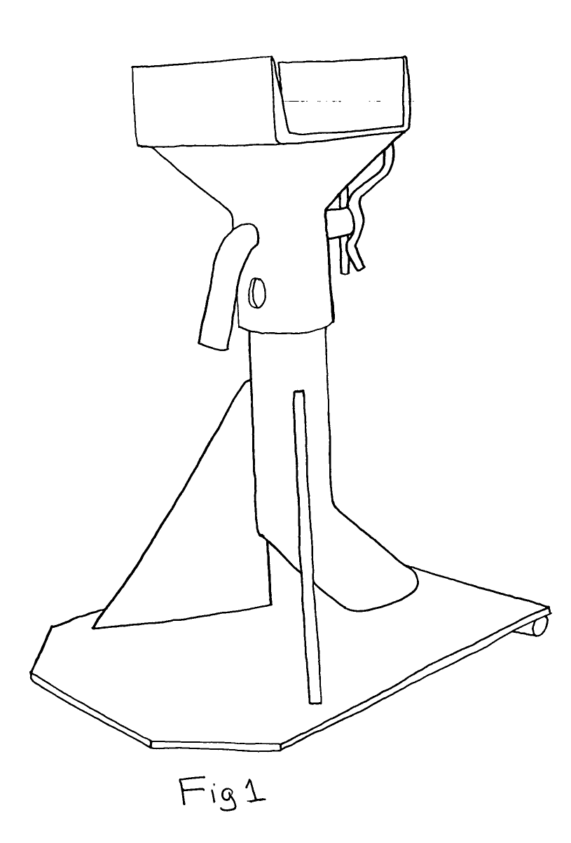

FIG. 2 is a side perspective view of a first embodiment of the claimed invention.

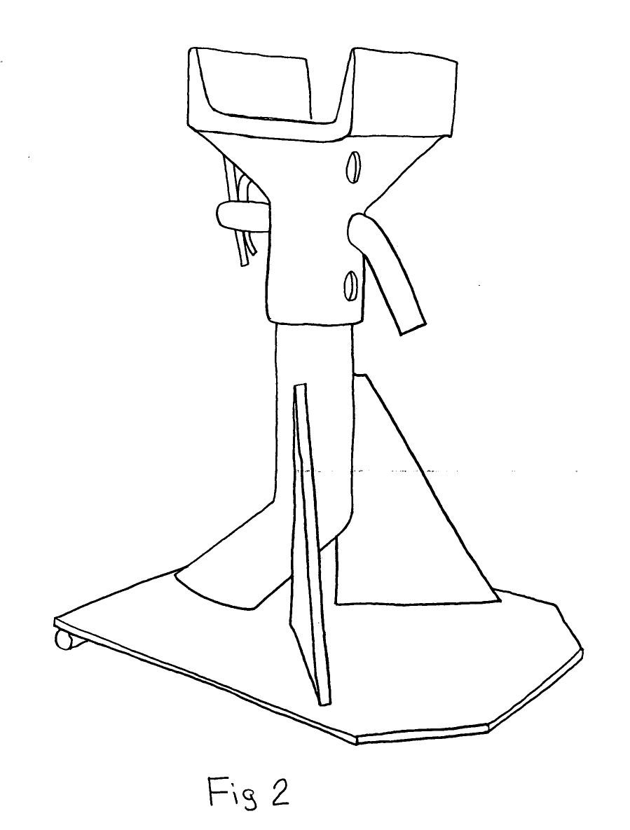

FIG. 3 is an exploded view of a first embodiment of the claimed invention.

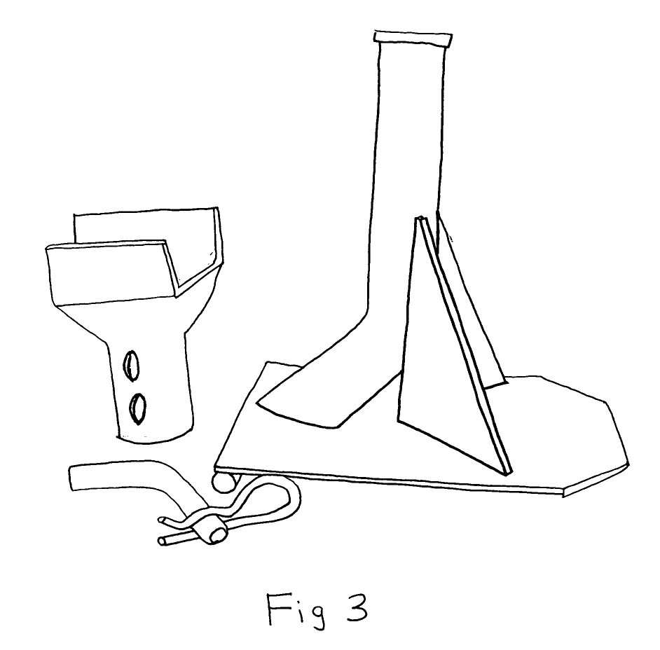

FIG. 4 is a side elevational view of a first embodiment of the claimed invention.

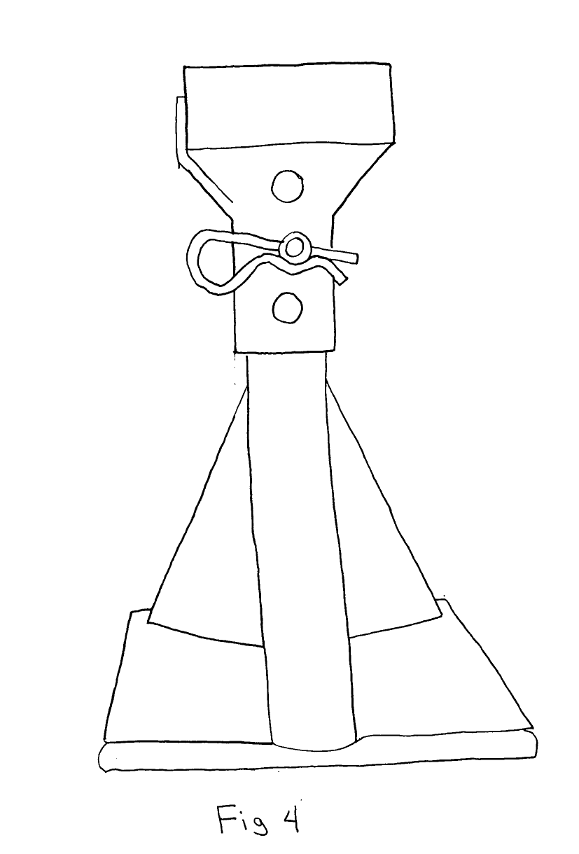

### DETAILED DESCRIPTION

The Axle cradle (or top) is constructed using 4″×4″ square Schedule 80 Channel Iron in order to accommodate any axel up to a torsion axel of 3½ inches. This cradle is welded to a piece of 2″ O.D. (outside diameter)×4″ schedule 80 pipe with three equally spaced 1 1/16th inch holes drilled through the pipe for height adjustment. The channel iron is gusseted on each corner with 1½″×1½″× 3/16″ inch steel. The axle cradle piece slides over the support piece and is adjusted with the pin described below.

The base consists of an 8″×10″ sheet of flat 3/16″ steel. The two corners of the front of the base have 1½″×1½″ cut diagonally from the corners, which eliminates sharp corners (the pivot being the rear of the jack).

Pivot point is a piece of 1/2″8″ re-bar solidly welded to the bottom end of the base, to create the necessary traction to pivot the jack onto the upright position when the power vehicle is moved forward or in reverse.

The support pipe is two pieces of 1⅝″ O.D. schedule 80 pipe. The longer piece (top piece) is cut at a 90 degree angle at one end and a 22½ degree angle at the opposite end. The shorter piece (bottom piece) is cut at a 45 degree angle at one end and a 22½ degree angle at the opposite end. The two 22½ degree angles are then welded together to form an overall 90 angle to the base. The 45 degree angle is welded flush to the rear divot end of the base. An 1 1/16″ hole is drilled in the top of the support piece in order to attach the cradle with the adjustment pin. The adjustment pin is an 11/16″ pin with a 20,000 lb. Shear capacity.

Support gussets are 4″×6″× 3/16″ flat steel welded at right angles to the support pipe and to the base of the jack, in a triangular configuration.

1. An axle-jack for using the momentum of a vehicle to raise the vehicle above the surface, the jack comprising:
a planar base with a top and a bottom;
a pivot rod disposed on the bottom of the base parallel to the distal end of the base;
a hollow vertical supporting post connected to the base, said supporting post having opposed apertures at the distal end thereof;
a telescoping post slidably engaged with the supporting post, said telescoping post having opposed apertures along the length thereof;
a securing pin insertable into and through the apertures of the supporting post and telescoping post to lock the telescoping post into a selected position; and
an arcuate cradle attached to the distal end of the telescoping post.

2. The axle-jack of claim 1 further comprising braces attached to the supporting post and the base.

3. The axle-jack of claim 1 further comprising an engagement tooth disposed on the bottom of the base parallel to the near end of the base.
